(19) United States
(12) Patent Application Publication
(10) Pub. No.: US 2019/0057636 A1
(43) Pub. Date: Feb. 21, 2019

(54) METHOD OF DISPLAYING FRAME RATE

(71) Applicant: ASUSTeK COMPUTER INC., Taipei (TW)

(72) Inventors: Ren-Wen TSAI, TAIPEI (TW); Chun-I SOONG, TAIPEI (TW); Yo-Lin CHANG, TAIPEI (TW); Po-Yu KUO, TAIPEI (TW)

(21) Appl. No.: 16/100,316

(22) Filed: Aug. 10, 2018

Related U.S. Application Data
(60) Provisional application No. 62/546,014, filed on Aug. 16, 2017.

(30) Foreign Application Priority Data
Jul. 10, 2018 (TW) 107123888

(51) Int. Cl. G09G 3/20; G06T 11/20

(52) U.S. Cl. CPC G09G 3/2018; G09G 3/2096; G06T 11/206

(57) ABSTRACT

A method of displaying frame rate includes the following steps. First, a quantity of image display units of a display is detected. Then, a plurality of refresh rate images are provided according to the quantity of image display units and by using an on-screen display manipulation function. A refresh rate of the display is calculated, to provide refresh rate data. One of the refresh rate images corresponding to the refresh rate data is determined, and is displayed on the display.

### CROSS-REFERENCE TO RELATED APPLICATION

This application claims the priority benefit of U.S. Provisional Application Ser. No. 62/546,014, filed on Aug. 16, 2017, and Taiwan application serial No. 107123888, filed on Jul. 10, 2018. The entirety of the above-mentioned patent application is hereby incorporated by reference herein and made a part of the specification.

### BACKGROUND OF THE INVENTION

### Field of the Invention

This disclosure provides a method of displaying frame rate, and in particular, relates to a method of displaying frame rate by using on-screen display (OSD).

### Description of the Related Art

Along with the progress of technologies, application of computer products becomes wider and goes deep into each family and industry, and computer games become popular with people in recent years. When a display card cannot support a computation load required by a game, display images of the game often lag or flicker. A game player can improve system efficiency by changing settings of the display card or upgrading the display card.

However, although a game player can obtain a current refresh frequency of images through computer software, the calculation of the refresh frequency occupies some system calculation resources to execute related software in a computer. Therefore, generally, to save the system calculation resources, the game player does not always execute related software. However, when the software for calculating the image refresh frequency is not executed, the game player cannot immediately obtain an actual refresh frequency of images in real time and thus cannot effectively improve the system efficiency.

### BRIEF SUMMARY OF THE INVENTION

The disclosure provides a method of displaying frame rate, including the following steps. First, a quantity of image display units (fonts) of a display is detected. Then, a plurality of refresh rate images are provided according to the quantity of image display units and by using an on-screen display manipulation function. A refresh rate of the display is calculated to provide refresh rate data. One of the refresh rate images corresponding to the refresh rate data is determined, and is displayed on the display.

In conclusion, in the method of displaying frame rate, the refresh rate is displayed on a corner of the display by using the on-screen display (OSD) manipulation function. Not only a computation resource of a computer is saved, but also a related refresh rate is instantly displayed. A game player notices whether a display card matches with the display, and appropriately upgrades a peripheral device correspondingly, so that the system provides better game performance. In addition, by cooperation of a refresh rate trend chart, the game player notices a change of the refresh rate on the display and makes a proper peripheral device upgrade decision.

### BRIEF DESCRIPTION OF THE DRAWINGS

To make the foregoing and other objectives, features, advantages, and embodiments of this disclosure more obvious and easily understood, descriptions of the accompanying drawings are as follows:

FIG. 1 is a schematic diagram of a method of displaying frame rate according to an embodiment of this disclosure;

FIG. 2 is a schematic diagram of a displayed image on a display in a method of displaying frame rate according to an embodiment of this disclosure; and

FIG. 3 is a schematic diagram of a displayed image on a display in a method of displaying frame rate according to another embodiment of this disclosure.

### DETAILED DESCRIPTION OF THE EMBODIMENTS

The following is a detailed description of the embodiments with reference to the accompanying drawings, which are not intended to limit the scope of the disclosure, and the description of the operation of the structure is not intended to limit the order of execution thereof. Any device with the same effects shall fall within the disclosure as long as its structure is merely recombination of components described herein. In addition, the drawings are for illustrative purposes only and are not drawn to the original dimensions. For ease of understanding, the same or similar elements in the following description are denoted by the same reference numerals.

In addition, the terms used in the entire specification and the claims, unless otherwise specified, usually express the normal meaning in the field, in the content disclosed herein and in the special content. Certain terms used to describe the disclosure are discussed below or elsewhere in this specification to provide additional guidance to those skilled in the art about the description of the disclosure.

“First”, “second”, and the like herein do not specifically indicate the order or sequence, and are not intended to limit the disclosure, but are merely to distinguish elements or operations described with the same technical terms.

The terms “comprise”, “include”, “have” and “contain” used in this specification are all open terms, that is, mean “including, but not limited to”.

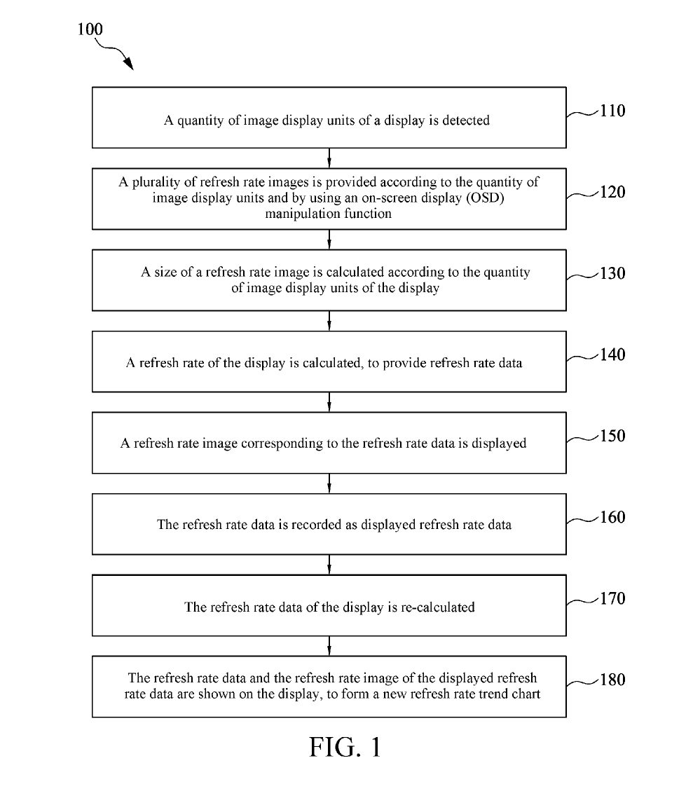

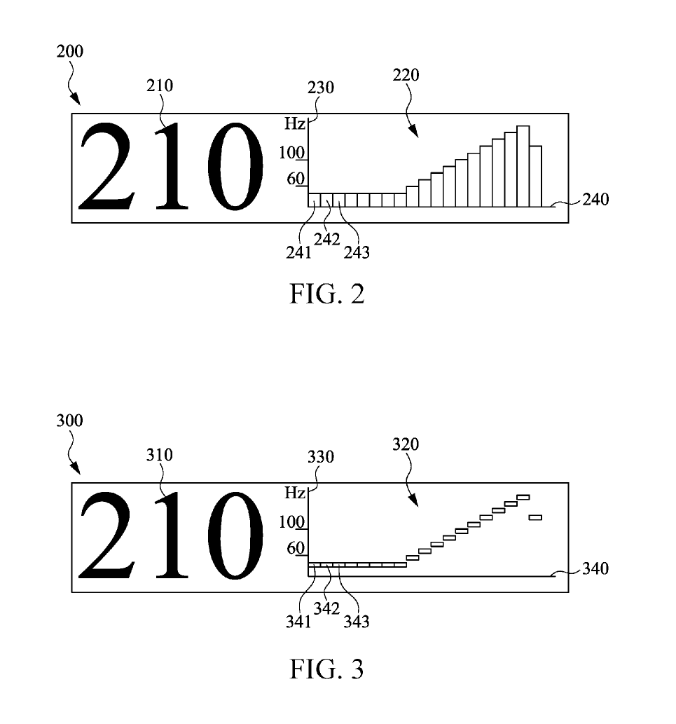

FIG. 1 is a schematic diagram of a method of displaying frame rate according to an embodiment of this disclosure; FIG. 2 is a schematic diagram of a displayed image on a display in a method of displaying frame rate according to an embodiment of this disclosure; and FIG. 3 is a schematic diagram of a displayed image on a display in a method of displaying frame rate according to another embodiment of this disclosure.

As shown in FIG. 1, a method of displaying frame rate 100 includes the following steps. First, step 110: A quantity of image display units of a display is detected. For example, a quantity of image display units of a scaler integrated circuit (scaler IC) of the display is detected. Step 120: A plurality of refresh rate images is provided according to the quantity of image display units and by using an on-screen display (OSD) manipulation function.

Referring to FIG. 2, the refresh rate image 200 includes a refresh rate value 210 and a refresh rate trend chart 220. The refresh rate trend chart 220 includes a refresh rate data chart 241, a first displayed refresh rate data chart 242, and a second displayed refresh rate data chart 243. A Y axis 230 represents frequency of a refresh rate, and an X axis 240 represents lapse of time. Being closer to the left means being closer to the refresh rate data chart, and being closer to the right means being closer to the previous displayed refresh rate data charts.

In an embodiment, the displayed refresh rate data chart includes a refresh rate data chart of previous five seconds of the display.

In an embodiment, the refresh rate image is a colorful refresh rate image. For example, when a refresh frequency is 200 Hz, the refresh rate image is green. When the refresh frequency is lower than 60 Hz, the refresh rate image is red. When the refresh frequency is between 60 Hz and 200 Hz, the refresh rate image is in a mixed color of red and green according to a proportion. As a result, a game player clearly learns whether a current refresh frequency is normal.

Referring to step 130, a size of a refresh rate image is calculated according to the image display units of the display. Generally, different displays have different resolutions, and the size of the refresh rate image 200 needs to be properly set, so that the game player can clearly see a message about the refresh frequency, and the refresh rate image 200 does not occupy too much space of the display.

Using an example of a refresh rate image 200 with 432 horizontal pixels and 72 height pixels, a total of 36*4 image display units (fonts) are needed. Each image display unit includes 12*18 pixels. If 0.2 MB (Megabyte) memory is required for full-color display (4 byte/pixel), when a resolution of the display needs to be improved, the memory capacity also needs to be increased accordingly, to maintain a refresh rate image 200 with the same size. A refresh rate image 200 with a proper size can be calculated by detecting the quantity of image display units of the scaler integrated circuit of the display without occupying much memory capacity. Besides, when the memory capacity is insufficient, a relatively small refresh rate image 200 is selected, to reduce the needed memory capacity. In addition, if it is selected to display only the refresh rate value 210 or only the refresh rate trend chart 220, the occupied image display units of the scaler integrated circuit can also be reduced. Generally, more image display units display more changes on the screen, but occupy more memory capacity. In the method of displaying frame rate 100, a proper refresh rate image 200 is selected according to the quantity of image display units and a screen resolution.

Then, step 140: A refresh rate of the display is calculated to provide refresh rate data. In an embodiment, refresh rate data of the display is read via a Display Data Channel Command Interface (DDC/CI).

Step 150: On the display, a refresh rate image 200 corresponding to the refresh rate data is displayed. In an embodiment, a proper refresh rate image 200 is selected and displayed. The selection is performed by a user or is automatically performed by the display according to the quantity of image display units, which is not limited herein.

Then, step 160: The scaler integrated circuit records the refresh rate data as displayed refresh rate data. In an embodiment, the displayed refresh rate data is the first displayed refresh rate data chart 242 and the second displayed refresh rate data chart 243 in FIG. 2.

Step 170: The refresh rate data of the display is re-calculated. Step 180: The refresh rate data and the refresh rate image of the displayed refresh rate data are shown on the display, to form a new refresh rate trend chart 220.

In an embodiment, step 140 of the calculating a refresh rate of the display, to provide refresh rate data further includes synchronizing display card refresh rate data of a display card with the refresh rate data of the display, so that the refresh rate of the display is consistent with that of the display card, thereby improving display effects of the display.

Referring to FIG. 3, FIG. 3 is a schematic diagram of a displayed image on a display in a method of displaying frame rate according to another embodiment of this disclosure. The refresh rate image 300 includes a refresh rate value 310 and a refresh rate trend chart 320. The refresh rate trend chart 320 includes a refresh rate data chart 341, a first displayed refresh rate data chart 342, and a second displayed refresh rate data chart 343.

A Y axis 330 represents frequency of a refresh rate, and an X axis 340 represents lapse of time. Being closer to the left means being closer to the refresh rate data chart, and being closer to the right means being closer to the previous displayed refresh rate data charts. In the refresh rate trend chart 320, the refresh rate data chart 341, and the displayed refresh rate data charts such as the first displayed refresh rate data chart 342, and the second displayed refresh rate data chart 343 are displayed in spot patterns, which, together with an image originally shown on the display, make the refresh rate image 300 easier to recognize, and reduce an occupied display area of a game on the display.

In an embodiment, the displayed refresh rate data chart includes a refresh rate data chart of a previous predetermined time of the display, and the predetermined time is, for example, five to ten seconds, which is not limited herein. In addition, the refresh rate image is a colorful refresh rate image. For example, when the refresh frequency is 200 Hz, the refresh rate image is green, and it indicates that the display presents a very smooth display speed. When the refresh frequency is lower than 60 Hz, the refresh rate image is red, and it indicates that the display operates at an excessively low refresh speed and presents a frame lag phenomenon or a frame flicker phenomenon. When the refresh frequency is between 60 Hz and 200 Hz, the refresh rate image is in a mixed color of red and green according to a proportion, to make a game player clearly learn whether the current refresh frequency is normal.

In some embodiments, the scaler integrated circuit re-reads and displays the refresh rate of the display every 250-400 milliseconds (ms). Using an interval of 250 milliseconds as an example, four refresh rate data charts are used to represent a refresh rate change situation in one second, and only 20 refresh rate data charts are needed to display refresh rate changes of previous five seconds. While operating a game, the game player correctly learns of refresh rate changes of the display at idle time of the game, and does not need to constantly watch value changes of the refresh rate, thereby effectively avoiding interference with operations of the game player on the game.

In conclusion, in the method of displaying frame rate, the current refresh rate of the display is directly read by using the scaler integrated circuit (scaler IC) of the display and is displayed on a corner of the display by using an OSD function. Not only a computation resource of a computer is saved, but also a related refresh rate is instantly displayed. A game player notices whether a display card matches with the display, and appropriately upgrades a peripheral device correspondingly, so that the system provides better game performance. In addition, by using a refresh rate trend chart, the game player notices a change of the refresh rate on the display and makes a proper peripheral device upgrade decision.

Although this disclosure is described with reference to the above embodiments, the embodiments are not intended to limit this disclosure. A person of ordinary skill in the art may make variations and improvements without departing from the spirit and scope of this disclosure. Therefore, the protection scope of this disclosure should be subject to the appended claims.

What is claimed is:

1. A method of displaying frame rate, comprising:
detecting a quantity of image display units of a display;
providing a plurality of refresh rate images according to the quantity of image display units and by using an on-screen display (OSD) manipulation function;
calculating a refresh rate of the display, to provide refresh rate data; and
determining one of the refresh rate images corresponding to the refresh rate data, and displaying the refresh rate image on the display.

2. The method of displaying frame rate according to claim 1, further comprising:
recording the refresh rate data as displayed refresh rate data.

3. The method of displaying frame rate according to claim 2, further comprising:
re-reading the refresh rate data of the display by using a Display Data Channel Command Interface.

4. The method of displaying frame rate according to claim 2, further comprising:
displaying the refresh rate images of the refresh rate data and of the displayed refresh rate data on the display.

5. The method of displaying frame rate according to claim 2, wherein a chart of the displayed refresh rate data comprises a refresh rate data chart of the display at a current predetermined time.

6. The method of displaying frame rate according to claim 1, wherein the refresh rate image further comprises a refresh rate data chart.

7. The method of displaying frame rate according to claim 1, wherein the refresh rate image further comprises a displayed refresh rate data chart.

8. The method of displaying frame rate according to claim 1, wherein the refresh rate image is a colorful refresh rate image.

9. The method of displaying frame rate according to claim 1, wherein the refresh rate image comprises a refresh rate value.

10. The method of displaying frame rate according to claim 1, further comprising:
synchronizing display card refresh rate data of a display card with the refresh rate data of the display.
